(19) United States
(12) Patent Application Publication
(10) Pub. No.: US 2018/0127221 A1
(43) Pub. Date: May 10, 2018

(54) SYSTEMS AND METHODS FOR TRANSFERRING GRANULAR MATERIAL

(71) Applicant: Transload Equipment, LLC, Corpus Christi, TX (US)

(72) Inventors: Michael Mintz, Corpus Christi, TX (US); Ron Wheaton, Corpus Christi, TX (US)

(73) Assignee: Transload Equipment, LLC

(21) Appl. No.: 15/345,068

(22) Filed: Nov. 7, 2016

(51) Int. Cl. B65G 67/24; B65G 15/00

(52) U.S. Cl. CPC B65G 67/24; B65G 2814/032; B65G 2201/045; B65G 15/00

(57) ABSTRACT

Embodiments described herein include systems and methods for safely and efficiently transferring granular material from a container. An example system can include a container for transporting granular material that includes a valve positioned to discharge the granular material from the container. The system can also include a frame shaped to receive and support the container. The system can further include an actuator mounted to the frame and oriented such that actuation of the actuator causes the valve of the container to be opened. Finally, the system can include a conveyor positioned to receive granular material from the container when the valve of the container is opened.

### DESCRIPTION OF THE EMBODIMENTS

### Field of the Embodiments

The embodiments herein relate generally to systems and methods for safely transferring granular material, and, more specifically, to improved systems and methods for safely transporting granular agricultural and industrial materials such as cement, barite, and sand for use in hydrocarbon fracking operations.

### BACKGROUND

Working with certain types of granular material can pose significant health risks. According to the U.S. Occupational Safety & Health Administration (“OSHA”), inhalation of small crystalline silica particles puts workers at risk for silicosis, lung cancer, chronic obstructive pulmonary disease, as well as liver, heart, and kidney disease. With the increase of hydraulic fracturing (“fracking”) over the past five to ten years, the instances of sicknesses and deaths due to silica inhalation have rapidly increased. Many fracking sites fail to meet current OSHA standards. Moreover, OSHA has proposed a new rule lowering the permissible exposure limit of respirable crystalline silica per cubic meter of air. This lower limit will impact almost any industry that involves transporting or otherwise using silica.

Fracking is a process for stimulating an oil well by fracturing underground rock using a pressurized liquid. The pressurized liquid consists primarily of water mixed with a proppant. A typical proppant is sand, such as “frac sand,” although other granular materials can be used as well. The proppant functions to maintain an induced hydraulic fracture open such that the desired oil or gas can be extracted. A single fracking well can require several thousand tons of frac sand.

Frac sand is mined and processed in a plant to improve its performance characteristics. The sand then gets transported from the plant to the fracking site. This transportation process can involve trains, ships, trucks, conveyors, and other transportation methods. Pneumatic pipe systems and conveyors are routinely used to transport sand from one container to another—for example, from a rail car to a truck or from a truck to a storage facility. Pneumatic and conveyor transfers allow silica particles to permeate the air in the surrounding area, causing a potential health hazard to any workers nearby.

A proposed solution to reduce silica exposure involves using sealed containers to transfer frac sand to the fracking site. By using the containers, a number of intermediate transfer steps can be avoided—for example, instead of pneumatically transferring frac sand from a train to a truck, sealed containers can be transferred from the train to the truck. Likewise, instead of pneumatically transferring sand from a truck to intermediary storage at the well site, the sand can be directly conveyed to the well.

While sealed containers provide obvious advantages over transferring loose frac sand, improvements are required at the fracking site in order to efficiently expel the frac sand from the containers so that the sand can be used in the fracking process. Additionally, these improvements need to provide workers with safety from airborne silica particles. The improvements should also provide cost savings for the well-site operator.

Therefore, a need exists for improved systems and methods for transferring granular material. More specifically, a need exists for systems and methods for transferring granular material from sealed containers loaded on a transportation vehicle, to a second storage location appropriate for using the material in the fracking process.

### SUMMARY

Embodiments described herein include systems and methods for safely and efficiently transferring granular material from a container. As described herein, the terms “container,” “sealed container,” and “sand container” are used interchangeably to mean any type of container that can be used for storing or transporting granular material. An example container is described in U.S. patent application Ser. No. 15/002,254, which is incorporated by reference herein in its entirety. Typically, a container is sized such that it can be loaded on a truck, trailer, railcar, or other vehicle by way of a crane, lift, or forklift. However, any type of container can be used. The container can include at least one exit valve through which granular material can be expelled from the container.

In one embodiment, a method includes positioning a container for transporting granular material on a transport vehicle. The terms “transport vehicle” and “vehicle” are used interchangeably throughout this disclosure and are not intended to be limiting in any way. Example transport vehicles include, for example, railcars, trucks, trailers, and sand-dispersing vehicles such as a SAND KING or SAND CHIEF. In some cases, the sand-dispersing vehicle might be a trailer towed by a tractor. Any type of sand-dispersing device can be considered a “transport vehicle” for the purposes of this disclosure.

Positioning the container on the transport vehicle can include, for example, moving the container from another vehicle or location and placing it on, or in, the transport vehicle. For example, this step can include lifting the container from the bed of a truck and placing it on a sand-dispersing vehicle. In another example, this step can include using a forklift to load a filled container onto a semi-trailer truck. This step can optionally include securing the container to the transport vehicle. For example, the containers can be strapped down, bolted, or otherwise coupled to the transport vehicle.

After the container is positioned on the transport vehicle, a further step of the method can include accessing a valve of the container to expel the contents of the container. This can include, for example, opening a valve that is closed. Although any type of valve can be used, this disclosure focuses mainly on a linearly slidable valve. That is, the valve is operated by linear movement of a disk along a shaft. In some examples, the valve disk can be displaced vertically, such that its direction of motion lies along a central, longitudinal axis of the container.

An actuator can be utilized to access the valve of the container. The actuator can include any component that moves or controls a mechanical system. For example, the actuator can be electric, mechanical, pneumatic, hydraulic, or some combination thereof. The actuator can also be comprised of multiple actuators working in conjunction with one another. At least one of the actuators can be mounted to a frame associated with the transport vehicle. The frame associated with the transport vehicle can be any structural component of the transport vehicle itself, or a structural component coupled to the vehicle for the purpose of unloading the container. For example, the frame can be a structural cradle that is secured to the top of the transport vehicle. The actuator, mounted to the frame, can be used to open the valve of the container, releasing the granular material within the container.

A further step in the method can include, as a result of accessing the slidable valve, causing the granular material to exit the container onto a conveyor. Conveyors are commonly used to transport material from one location to another, especially when the material needs to be transported to a higher elevation. Conveyors have an added benefit over pneumatic transfers in that they do not release as many airborne silica particles, and does not aerosolize the silica by forcibly breaking the silica into microscopic particles.

A standalone conveyor system can be positioned underneath the transport vehicle in a location that receives the granular material released from the container. In other examples, the conveyor system can be a component of the transport vehicle itself. For example, some sand-dispersing vehicles include a conveyor system built into the vehicle. The methods and systems described herein can be used in conjunction with either type of conveyor system, or any other available system.

In addition to the example method summarized above, an example system is provided for transferring granular material from a container to a conveyor. The system can include a container for transporting granular material that includes a valve positioned to discharge the granular material from the container. The system can also include a frame shaped to receive and support the container. The system can further include an actuator mounted to the frame and oriented such that actuation of the actuator causes the valve of the container to be opened. Finally, the system can include a conveyor positioned to receive granular material from the container when the valve of the container is opened.

A detailed description of these examples, and other examples, is provided below. Both the foregoing general description and the following detailed description are exemplary and explanatory only and are not intended to restrict the scope of the invention as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an illustration of an example system for transferring granular materials from containers loaded on a semi-trailer truck to a conveyor system.

FIG. 2 is an illustration of an example system for transferring granular materials from containers loaded in a sand-dispersing vehicle to a conveyor system built into the vehicle.

FIG. 3 is an illustration of an example system for transferring granular materials from containers that are loaded on a frame coupled to a sand-dispersing vehicle, to a conveyor system built into the vehicle.

FIG. 4A is an illustration of an example actuators for operating a valve of a container.

FIG. 4B is an illustration of an example actuators for operating a valve of a container.

FIG. 4C is an illustration of an example actuators for operating a valve of a container.

FIG. 5 is a flow chart of an example method of transferring granular material from a container to a conveyor.

### DETAILED DESCRIPTION

Reference will now be made in detail to the present exemplary embodiments, including examples illustrated in the accompanying drawings. Wherever possible, the same reference numbers will be used throughout the drawings to refer to the same or like parts.

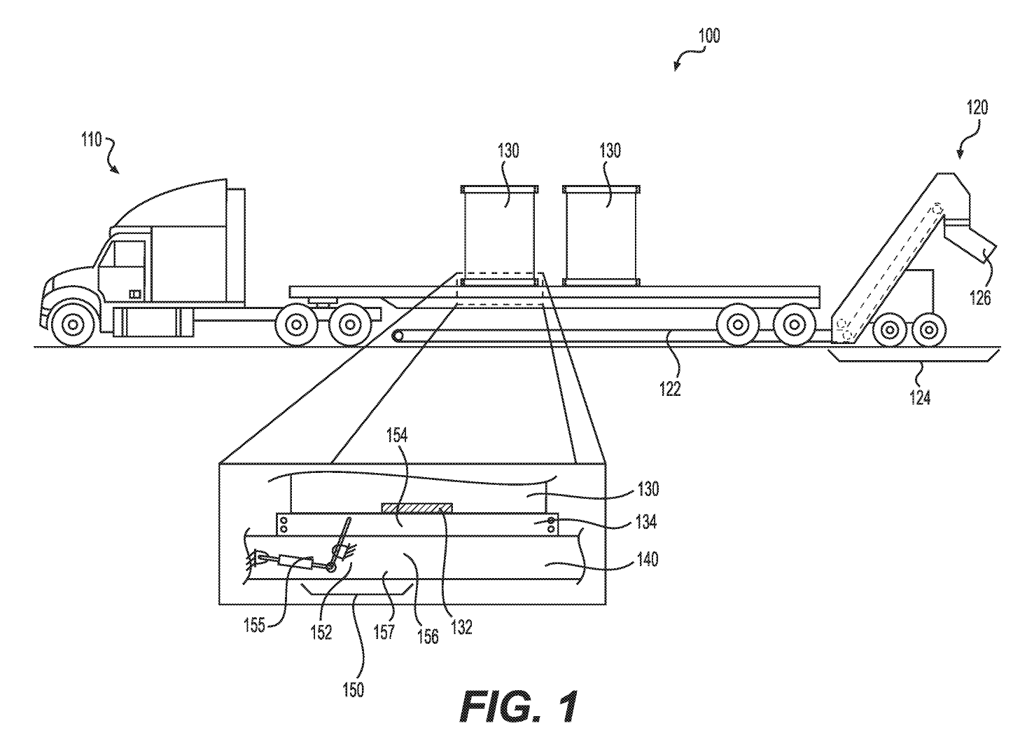

In a first example depicted in FIG. 1, a system 100 is disclosed including a truck 110 and a conveyor system 120. In this example, the truck 110 is carrying two containers 130 filled with a granular material, such as a proppant intended for use in a fracking process. In other examples, the truck 110 can carry a different number of containers 130, including any number from one to six. If smaller containers 130 are used, even more containers 130 can be loaded on the truck 110. However, in this example two containers 130 are used, as this number can provide a balance between portability and efficient loading and unloading.

The containers 130 can be loaded onto the truck 110 using a forklift, crane, lift, MOBICON lift, or any other lifting mechanism. For example, each container 130 can be shaped to accept the lifting prongs of a forklift, such that the container 130 can be lifted and moved without the use of a larger piece of machinery such as a crane. Each container 130 can be placed on the trailer of the truck 110 and then secured with tie-down straps or fasteners. The containers 130 can also be secured to one another to prevent tipping over.

As shown in FIG. 1, the truck 110 is positioned above a conveyor system 120. The conveyor system 120 is shown above ground level, but in some embodiments the conveyor can be oriented flush with the ground, or even below ground level. Additionally, the conveyor can be oriented in any direction, such that it transports granular material in a direction toward the rear, the front, or either side of the truck 110. In FIG. 1, a conveyor belt 122 is shown oriented such that it conveys material in a direction toward the rear of the truck 110.

In this example, the conveyor system 120 also includes a dispersing section 124. The dispersing section 124 can include a section of conveyor belt 122 that is oriented at an inclined angle with respect to the ground, or can include an additional conveyor belt inclined with respect to the ground and the other conveyor belt 122. The dispersing section 124 can also include an adjustable nozzle 126 that can be oriented in a variety of directions, such that an operator can control the process of dispersing proppant in a precise manner. The nozzle 126 can be adjustable by hand or by an actuation mechanism controlled by an operator.

To unload the proppant from the containers 130, the truck 110 can include one or more actuation mechanisms 150. In some examples, each container 130 is associated with one actuation mechanism 150. In other examples, the truck 110 includes more than one actuation mechanism 150 for each container 130. Any number of actuation mechanisms 150 can be used.

The actuation mechanism 150 can be mounted to a frame 140 of the truck 110 in one example. As explained above, the frame 140 of the truck can include any structural component of the truck 110, or any component attached to a structural component of the truck 110, and is not limited to the automotive definition of a “frame.” For example, a frame 140 can include a trailer bed, a hook attached to a trailer, a strut or support beam, an axle, or any other structural component of the truck 110. In the example of FIG. 1, the frame 140 is a structural member oriented longitudinally along the length of the truck 110. However, in other examples the frame 140 can be a cross-beam or other member extending laterally, or diagonally, with respect to a longitudinal axis of the truck 110.

The actuation mechanism 150 can be mounted to the frame 140 in one or more locations. In the example of FIG. 1, the actuation mechanism 150 is attached to the frame 140 via a first mount 155 and a second mount 156. Both the first and second mounts 155, 156 can include a rotatable coupling that allows the mounted component to rotate freely about the respective mount. The mechanism 150 also includes an actuator 152 attached at one end to the first mount 155, and attached at the other end to an actuation member 154. The actuator 152 and actuation member 154 can be coupled to one another via a rotatable coupling 157. The coupling 157 and the mounts 155, 156 can be any type of rotatable couplings, such as a pivot joint, pin joint, ball-and-socket joint, spherical bearing, radial bearing, or axial bearing. The actuation member 154 can be mounted to the frame 140 via the second mount 156.

When deployed, the actuator 152 can extend in an axial direction, applying force to the actuation member 154 via the rotatable coupling 157. By applying force to the actuation member 154, the actuator 152 can cause the actuation member 154 to rotate about the second mount 156. As a result of this rotation, a distal end of the actuation member 154 can contact a valve 132 of an associated container 130, applying sufficient force to open the valve 132. In the example of FIG. 1, the valve 132 opens by sliding along a guide. Further, in this example, the valve 132 opens by sliding in a direction perpendicular to a lower support member 134 of the container 130. Similarly, the valve 132 opens by sliding in a direction perpendicular to the frame 140 of the truck 110. The valve's 132 opening motion can also be described as sliding in a direction substantially orthogonal to the ground upon which the truck 110 is positioned.

Other types of valve 132 operation are also possible. In one example, the valve 132 is hinged such that the valve 132 opens by rotating about a hinge. In that example, the valve 132 can be opened by rotating the valve 132 upward, such that it extends further into the container 130, or downward, such that it extends toward the ground. In either case, the valve 132 would allow granular material to exit the container 130. In another example, the valve 132 is slidable in a horizontal direction, such as in a direction parallel to the support member 134 or the frame 140. Any type of valve 132 can be used, and the actuation mechanism 150 can be adjusted such that actuation of the actuator 152 causes the valve 132 to open.

Any type of actuator 152 can be used to open the valve 132. For example, the actuator 152 can include, but is not limited to, a machine-screw actuator, ball-screw actuator, electric actuator, pneumatic actuator, or hydraulic actuator. The actuator 152 can include a connector to receive a source of energy, such as electricity or compressed air/fluid, or both. The actuator 152 can also include a connector to receive a control signal from an operator. In a simple example, a button is provided near the actuator that, when pressed, causes the actuator to move from a first position to a second position, or vice versa.

In a more sophisticated example, a plurality of actuators 152 are tied together such that the actuators 152 work in conjunction with one another. For example, an electrical control signal can be sent to four actuators 152, with each actuator 152 positioned to open a valve 132 of a separate container 130. With a single press of a button, a control signal can be sent to all four actuators 152, causing each valve 132 to be opened simultaneously. In examples where the conveyor 122 is configured to handle the output of only one container 130 at a time, the electrical signal can be staged such that the containers 130 open sequentially.

In another example, each valve 132 is opened by a pair of actuation mechanisms 150. In that example, an electrical control signal can cause a pair of actuators 152 to operate simultaneously, such that the valve 132 experiences equal forces from each actuation mechanism 150. Additionally, the actuators 152 within a pair of actuation mechanisms 150 can by hydraulically paired, or balanced, with one another. For example, two hydraulic actuators 152 can include a fluid connection between one another, such that each actuator 152 experiences the same hydraulic pressure relative to one another. The fluid connection can equalize pressure differences across the multiple actuators 152. A similar fluid connection can link more than two actuators 152, such as in an example where three, four, or more actuators are used to open each valve 132. In examples where multiple containers 130 are to be emptied simultaneously, fluid connections can be used to link some or all of the hydraulic actuators 152 associated the various containers 130.

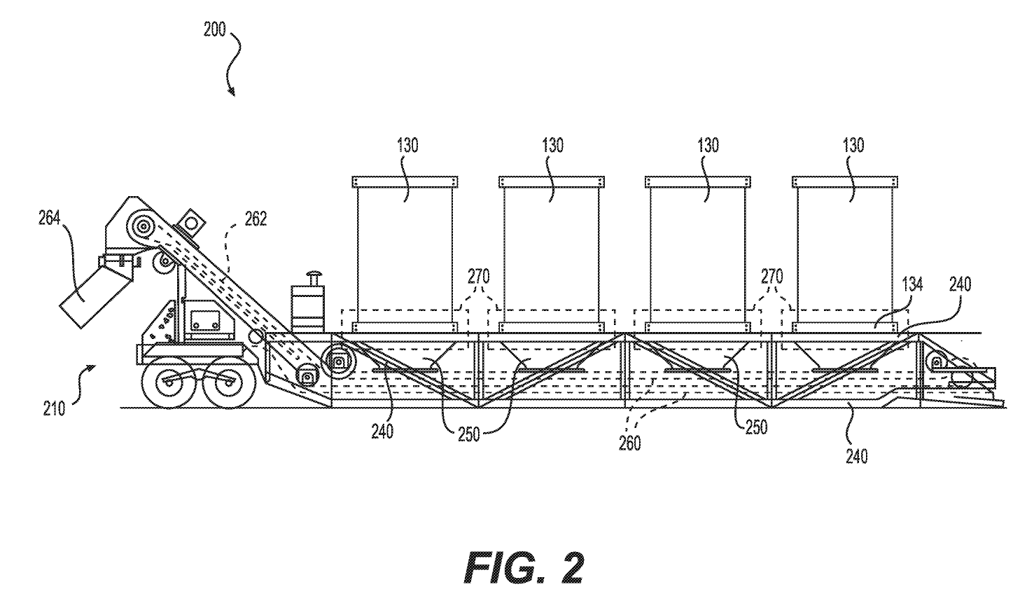

The actuation mechanism 150 depicted in FIG. 1 can also be implemented with other types of systems, such as on a sand-dispersing vehicle such as a SAND KING or SAND CHIEF. FIG. 2 provides an illustration of such a system 200. The sand-dispersing vehicle 210 can be modified to receive a plurality of containers 130, as shown in FIG. 2. The sand-dispersing vehicle 210 can include multiple hoppers 250, with each hopper 250 associated with a container 130. The containers 130 can be placed on the sand-dispersing vehicle 210 such that each container 130 is associated with one hopper 250. In one example, the containers 130 are lifted from the bed of a truck—using a forklift, for example—and placed on the frame 240 of the sand-dispersing vehicle 210. In another example, a mobile crane is used to lift each container 130 and place it on the sand-dispersing vehicle 210. In yet another example, a bridge crane can be positioned proximate the truck. The bridge crane can utilize a lifting mechanism, bridge beams, and rails to transfer the containers 130 from the truck to a sand-dispersing vehicle 210 or conveyor.

The containers 130 can be coupled directly to the hoppers 250 or can be attached to a portion of the frame 240 such that the containers 130 are aligned with the hoppers 250. In some examples, a hopper 250 can be considered a portion of the frame 240 of the sand-dispersing vehicle 210. In other examples, the hoppers 250 can be removed from the sand-dispersing vehicle 210 and the containers 130 can simply interface with the frame 240.

The sand-dispersing vehicle 210 can also include a conveyor belt 260 located underneath the hoppers 250, positioned to received granular material dispersed from the containers 130. In some examples the sand-dispersing vehicle 210 can include a secondary conveyor belt 262, positioned at an angle such that the granular material is carried up toward an adjustable nozzle 264 that can be used to direct the granular material as it exits the vehicle 210. In some examples, the nozzle 264 can include a hose, pipe, or tube that connects to the nozzle and allows for even more precise placement of the granular material—such as within an intermediate storage vehicle or a different sand-dispersing vehicle 210.

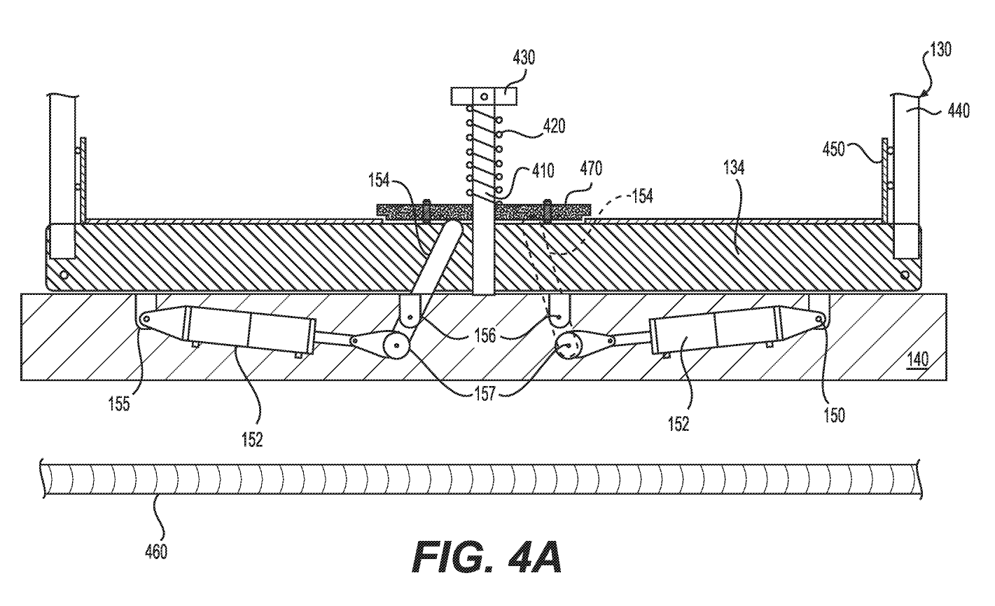

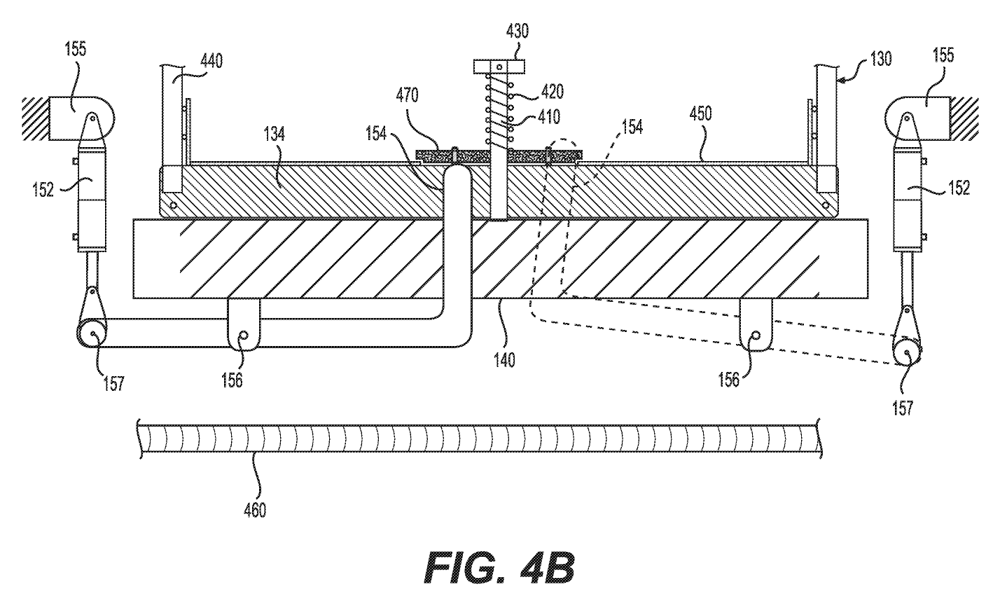

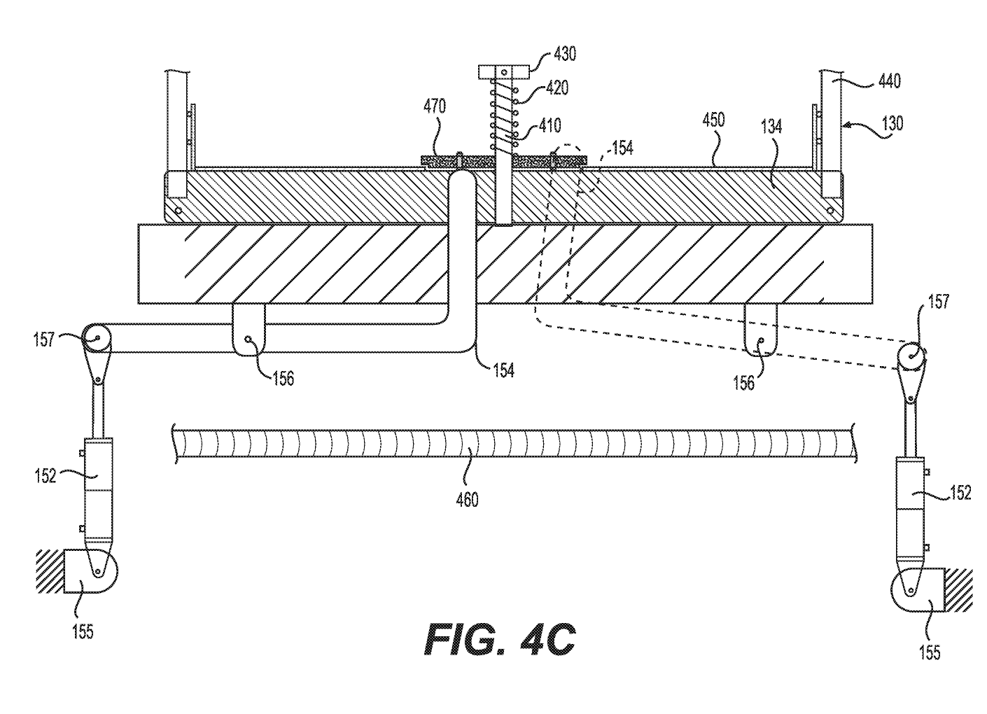

Similar to the example of FIG. 1, the example system 200 depicted in FIG. 2 can include one or more actuation mechanisms 270. Each actuation mechanism 270 can be associated with one container 130. In some example, an actuation mechanism 270 includes more than one actuator 152. Similar to the actuation mechanisms 150 described with respect to FIG. 1, the actuation mechanism 270 of FIG. 2 can be mounted to the frame 240 (including the hoppers 250) in one or more locations. Additional details on the actuation mechanism 270 is provided in the discussion of FIGS. 4A-4C.

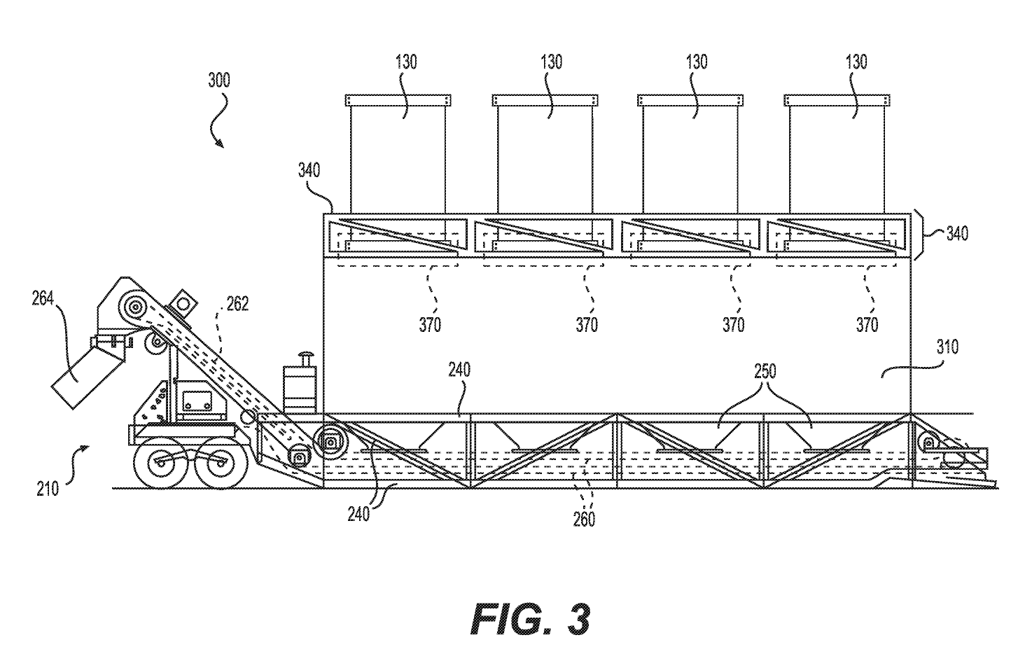

FIG. 3 provides an illustration of another example system 300 that implements a sand-dispersing vehicle 210 such as a SAND KING or SAND CHIEF. In the example of FIG. 3, the sand-dispersing vehicle 210 has been modified to accept four containers 130. Of course, it could be modified to accept more, or fewer, containers 130 in other implementations. As with FIG. 2, the sand-dispersing vehicle 210 of FIG. 3 retains conveyor belt 260 as well a secondary conveyor belt 262, the belts configured to work in concert to transport granular material that exits the hoppers 250 up to the adjustable nozzle 264 of the sand-dispersing vehicle 210. From there, the material can be dispersed from the nozzle 264, such as through a large hose that is directed into a wellbore.

The sand-dispersing vehicle 210 of FIG. 3 includes a lower frame 240, a body 310, and an upper frame 340. All of these components (240, 310, 340) can be considered a “frame” of the sand-dispersing vehicle 210. In some examples, the body 310 can house a portion of each hopper 250. In another example, the body 310 can house containers that feed the hoppers 250. In yet another example, the body 310 can include one large container for collecting material, which includes multiple outlets to feed the hoppers 250. In some examples, the body 310 of the sand-dispersing vehicle 210 is unchanged from a standard sand-dispersing vehicle 210. By foregoing extension modification to the sand-dispersing vehicle 210, the overall cost of the system 300 can be decreased, and the sand-dispersing vehicle 210 can retain the flexibility of being used with traditional proppant-transporting systems.

The upper frame 340 can be a lattice of structural members that can be coupled to the sand-dispersing vehicle 210. For example, the upper frame 340 can be coupled to the sand-dispersing vehicle 210 via fasteners, welds, interlocking joints, or any other method of coupling. For implementations where the sand-dispersing vehicle 210 is intended to be used for multiple purposes, removable fasteners can be used such that the upper frame 340 can be installed and removed whenever it is convenient to do so.

In one example, a method for transporting granular material includes installing an upper frame 340 on a sand-dispersing vehicle 210. Installing the upper frame 340 can include, for example, assembling the frame 340, lifting the frame 340, placing the frame 340 on the sand-dispersing vehicle 210—such as on the body 310 portion of the sand-dispersing vehicle 210—and coupling the frame 340 to the sand-dispersing vehicle 210. In some examples one or more forklifts, cranes, or other heavy equipment can be used to lift and maneuver the upper frame 340. Traditional fastening methods can be used to secure the upper frame 340 to the sand-dispersing vehicle 210.

Once the upper frame 340 is installed on the sand-dispersing vehicle 210, the containers 130 can be place on the upper frame 340. In one example, this involves lifting each container 130, using a forklift, crane, or other heavy equipment, from a first location and placing each container 130 on the upper frame 340. In some examples, the containers 130 can be placed on the body 310 with the upper frame 340 provided for additional support or for a location to attach actuation mechanisms 370. In some examples, actuation mechanisms 370 are included with the upper frame 340, such that installing the upper frame 340 also includes installing actuation mechanisms 370 configured to operate the valves 132 of the respective containers 130.

With the containers 130 secured to the sand-dispersing vehicle 210 via the upper frame 340, the actuation mechanisms 370 can be utilized to release granular material from the containers 130 in a manner similar to that described with respect to FIGS. 1 and 2. An operator can operate the actuation mechanisms 370 via any type of control mechanism, such as a button or level located in a position that is convenient for the operator to reach.

Opening the valves 132 of the containers 130 causes the granular material within the containers 130 to flow into the body 310 of the sand-dispersing vehicle 210. For example, this process can fill the hoppers 250 of the sand-dispersing vehicle 210. In some cases, the hoppers 250 can be opened while the valves 132 are opened, allowing the granular material to flow down to the conveyor belt 260 for further transport. In another example, the hoppers 250 can remain closed, such that the sand-dispersing vehicle 210 is filled and can be moved to another location to disperse the material.

The hoppers 250 can be positioned such that they empty the contents of the sand-dispersing vehicle 210, such as the granular material from the containers 130, onto a conveyor belt 260. The conveyor belt 260 can transport the material to a secondary conveyor belt 262, which leads to a nozzle 264 that directs the flow of material from the sand-dispersing vehicle 210. In some examples, a hose can be attached to the nozzle 264 to further direct the material as it leaves the sand-dispersing vehicle 210. For example, the hose can direct the granular material down a wellbore.

FIGS. 4A-4C provide illustrations of example actuation mechanisms. Each of FIGS. 4A-4C illustrate a portion of a container 130 that includes a lower support member 134, side support members 440, and a base plate 450. Each of these components can be made from a strong, robust material such as steel, Kevlar, carbon fiber, and metal alloys, or some combination thereof. The base plate 450 can enclose the container 130 with the exception of an aperture in the center of the base plate 450, which can be closed off by the valve plate 470. In some embodiments, one or more of the lower support member 134, the side support members 440, and the base plate 450 can be distinct components coupled together at one or more locations. In other embodiments, one or more of the lower support member 134, the side support members 440, and the base plate 450 can be integral with one another and/or composed of the same material.

While the lower support member 134 and the base plate 450 are depicted as substantially flat or planar in FIGS. 4A-4C, one or both of the lower support member 134 and the base plate 450 can be sloped toward the aperture in the base plate 450. Alternatively or additionally, base plate 450 may be conical in shape creating a downward-facing funnel not unlike the hoppers 250 described above. Such configurations can ensure that any material placed in the container 130 will be released through the aperture in the base plate 450 rather than collected in the corners (proximate the juncture of the base plate 450 and the side support members 440) of the container 130.

The valve 132 can be slidable along a post 410 that can be fixed or coupled to the lower support member 134. The post 410 can be welded to the lower support member 134, or multiple lower support members 134, in an example. A spring 420 can be provided around the post 410, with one side of the spring 420 abutting the valve plate 470 while the other side of the spring 420 abuts an end cap 430. The end cap 430 can be fixed or removable and is intended to retain the spring 420 on the post 410. The valve plate 470 can include an aperture in its center, through which the post 410 can extend. As a result, the valve plate 470 can slide up and down the post, with the spring 420 biasing the valve 132 toward a closed position.

The valve 132 is depicted as substantially flat or planar in FIGS. 4A-4C. In other embodiments, however, the valve 132 can be a different shape. For example, the valve 132 can be conical in shape with an upper surface that slopes downward toward the aperture in the base plate 450. Such a conical shape (opposite that described above with respect to the hoppers 250 and/or the base plate 450) may lessen the force required to open the valve 132 or reduce the likelihood of the valve 132 becoming stuck.

Sliding the valve plate 470 up the post 410, toward the end cap 430, can cause any granular material in the container 130 to flow out of the valve. This material would not be blocked by the lower support member 134 in the example embodiments of FIGS. 4A-4C because the lower support member 134 can be shaped such that it has a shallow depth relative to the viewpoint shown. For example, the lower support member 134 can be merely a few millimeters thick in the direction going into (or out of) the drawings shown in FIGS. 4A-4C (i.e., the z-axis). As a result, the material would drop down to the conveyor belt 460. The conveyor belt 460 can be a belt included as part of a sand-dispersing vehicle 210. In another example, the conveyor belt 460 can be a belt positioned under the containers 130, as shown in FIG. 1.

In the example of FIG. 4A, the actuation mechanism is mounted a portion of a frame 140 oriented directly underneath the container 130. As explained above, the frame 140 can include any structural portion of a transport vehicle, such as a truck, trailer, or sand-dispersing vehicle. The actuation-mechanism layout shown in FIG. 4A is similar to the mechanism shown in FIG. 1, in that the actuator 152 is mounted to a portion of the frame 140 directly under the container.

More specifically, FIG. 4A shows a set of first mounts 155 and second mounts 156, both of which are mounted to the portion of the frame 140 depicted in the drawing. An actuator 152 is coupled to each of the first mounts 155. The actuators 152 are respectively coupled to actuation members 154 via rotatable couplings 157. The actuation members 154 are, in turn, coupled to the second mounts 156 via rotatable couplings. As a result, actuation of the actuators 152 causes the distal ends of the actuation members 154 to slide the valve plate 470 along the post 410, toward the end cap 430. Sliding the valve plate 470 up the post 410 opens the valve such that any granular material in the container 130 flows out and is deposited on the conveyor 460.

In FIG. 4B, a pair of actuators 152 are shown positioned to open a valve plate 470 similar to that shown in FIG. 4A. The actuators of FIG. 4B are each attached, at one end, to first mounts 155 that are mounted to a portion of the frame other than the portion 140 shown in the drawing. For example, the first mounts 155 can be mounted to the upper frame 340 depicted in FIG. 3. As shown in FIG. 3, portions of the upper frame 340 can be situated above, rather than below, the valve plate 470. The actuation mechanism depicted in FIG. 4B can utilize a portion of the upper frame 340 to provide mechanical leverage to the bottom of the valve plate 370.

In particular, the actuators 152 of FIG. 4B are each rotatably mounted at one end to first mounts 155 positioned above the valve plate 470 (relative to the ground, for example). At their other ends, the actuators 152 are each attached to respective actuation members 154 via rotatable couplings 157. The actuation members 154 are, in turn, coupled to the second mounts 156 via rotatable couplings. The second mounts 156 can be located on a portion of the frame 140 underneath the container 130. In other examples, the second mounts 156 can be attached to other portions of the frame. In any event, when the actuators 152 are actuated, the distal ends of the actuation members 154 cause the valve plate 470 to slide along the post 410, opening the valve such that any granular material in the container 130 flows out and is deposited on the conveyor 460 for further transport.

FIG. 4C illustrates an example embodiment where the actuators 152 are mounted to first mounts 155 located at yet another portion of the frame. The example shown in FIG. 4C can illustrate an embodiment where the first mounts 155 are mounted to the lower frame 240 of a sand-dispersing vehicle 210, such as that shown in FIGS. 2 and 3. For the purposes of this disclosure, the hoppers 250 shown in those drawings can also be considered part of the lower frame 240. The first mounts 155 of FIG. 4C can be located on any part of the lower frame 240, in an example. In another example, the first mounts 155 are positioned on a different structural component of the sand-dispersing vehicle 210, such as an axle.

Similar to the previous examples, the actuators 152 of FIG. 4C are rotatably coupled to respective actuation members 154 via rotatable couplings 157. The actuation members 154 are mounted via second mounts 156 using rotatable couplings. The second mounts 156 can be mounted on the frame 140 section adjacent the container 130, as shown in the drawing, or on a different location of the frame 140. When the actuators 152 are applied, the distal ends of the actuation members 154 press against the valve plate 470, causing it to slide up the post 410 and thereby opening the valve to allow granular material in the container 130 to escape. The granular material can be deposited on the conveyor 460 and transported to a different location from there.

While FIGS. 4A-4C show pairs of actuators 152 used to operate the valve, any numbers of actuators 152 can be used in each example. When multiple actuators 152 are used, they can be synchronized with one another to ensure smooth opening and closing of the valve. For example, two hydraulic actuators 152 can include a fluid connection between one another, such that each actuator 152 experiences the same hydraulic pressure relative to one another. The fluid connection can equalize pressure differences across the multiple actuators 152. A similar fluid connection can link more than two actuators 152, such as in an example where three, four, or more actuators are used to open each valve 132. In examples where multiple containers 130 are to be emptied simultaneously, fluid connections can be used to link some or all of the hydraulic actuators 152 associated the various containers 130. When electricity-based actuators 152 are used, the control signals that provide directions to the actuators 152 can be synchronized, or can be delivered via a shared control signal path, such that each actuator 152 receives the same instruction.

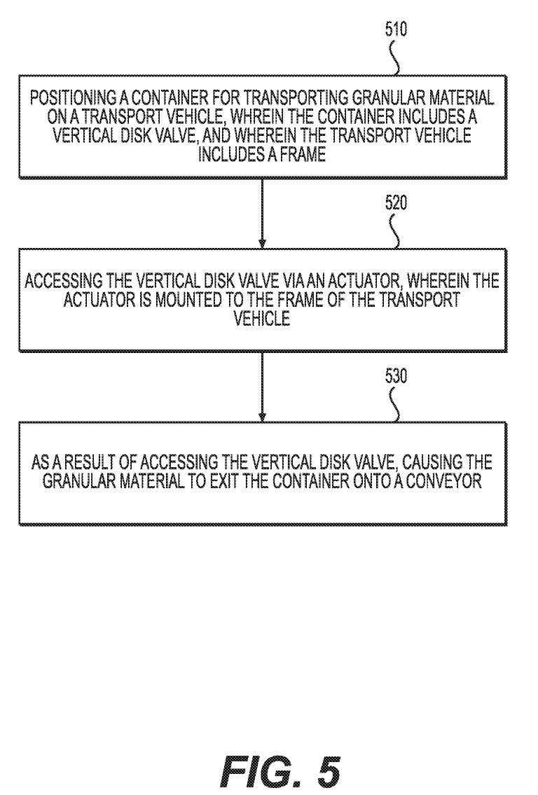

FIG. 5 provides a flow chart of an example method for transferring granular material from a container to a conveyor. Stage 510 of the method can include positioning a container for transporting granular material on a transport vehicle, such as a truck or sand-dispersing vehicle. The container can include a vertical disk valve. The transport vehicle can include a frame, such as the frame of a truck or trailer, or a lower or upper frame as described with respect to FIG. 3.

Stage 520 of the method can include accessing the vertical disk valve via at least one actuator. The actuator can be mounted to the frame of the transport vehicle, including an upper or lower frame, including a hopper, a frame of a truck or trailer, or any other structural support member.

Stage 530 of the method can include, as a result of accessing the vertical disk valve, causing the granular material to exit the container onto a conveyor. In some examples, the granular material exits the container, enters a hopper or other intermediary storage device, and then is deposited onto the conveyor. Both of these options are encompassed by the method depicted in FIG. 5.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of transferring granular material, comprising:
positioning a container for transporting granular material on a transport vehicle, wherein the container includes a slidable valve, and wherein the transport vehicle includes a frame associated with the transport vehicle;
accessing the slidable valve via an actuator, wherein the actuator is mounted to the frame associated with the transport vehicle; and
as a result of accessing the slidable valve, causing the granular material to exit the container onto a conveyor.

2. The method of claim 1, wherein the actuator is a pair of actuators that are calibrated to one another.

3. The method of claim 1, further comprising installing a structural member on the transport vehicle, wherein the frame comprises the structural member.

4. The method of claim 3, wherein the actuator is at least one of: a machine-screw actuator, ball-screw actuator, electric actuator, pneumatic actuator, and hydraulic actuator.

5. The method of claim 1, wherein accessing the slidable valve comprises displacing a spring-loaded disk along a shaft having an axis oriented perpendicular to a base of the container.

6. The method of claim 1, wherein the actuator is coupled to a member, and wherein the member is rotatably mounted to the frame of the transport vehicle.

7. The method of claim 1, wherein the transport vehicle is at least one of: a truck, a trailer, a rail car, and a sand-handling apparatus.

8. A system for transferring granular material, comprising:
a container for transporting granular material, the container comprising a central vertical axis and a valve positioned to discharge granular material from the container, the valve having a valve plate that opens by sliding along the central vertical axis of the container, wherein the valve plate is biased toward a closed position by a coil spring that applies a force in a direction parallel to the central vertical axis;
a frame of a vehicle, shaped to receive and support the container; and
an actuator mounted to the frame, wherein the actuator is oriented such that actuation of the actuator causes the valve of the container to be opened by sliding the valve plate along the central vertical axis.

9. The system of claim 8, further comprising a conveyor positioned to receive granular material from the container, and wherein causing the valve of the container to be opened causes the granular material to be discharged from the container to the conveyor.

10. The system of claim 8, wherein the actuator is a plurality of actuators that are configured to act in unison with one another.

11. The system of claim 8, wherein the actuator is a linear actuator.

12. The system of claim 8, wherein the actuator is at least one of: a machine-screw actuator, ball-screw actuator, electric actuator, pneumatic actuator, and hydraulic actuator.

13. The system of claim 8, wherein the frame is a component of a truck, trailer, rail car, or sand-handling apparatus.

14. The system of claim 8, wherein the actuator is coupled to a member, and wherein the member is rotatably mounted to the frame.

15. The system of claim 8, wherein the valve opens and closes via linear movement of the valve plate.

16. A system for receiving granular material from a container having a central vertical axis and a valve having a valve plate that opens by sliding along the central vertical axis of the container, wherein the valve plate is biased toward a closed position by a coil spring that applies a force in a direction parallel to the central vertical axis, comprising:
a frame of a vehicle, shaped to receive and support the container;
an actuator mounted to the frame, wherein the actuator is positioned such that actuation of the actuator causes the valve of the container to be opened by sliding the valve plate along the central vertical axis; and
a conveyor positioned to receive granular material from the container.

17. The system of claim 16, wherein the frame is shaped to receive and support a plurality of containers.

18. The system of claim 16, wherein the vehicle is a truck, trailer, rail car, or sand-handling apparatus.

19. The system of claim 16, further comprising a member coupled to the actuator and the frame, wherein causing the valve of the container to be opened further comprises applying force through the member to the valve.

20. The system of claim 16, further comprising a plurality of actuators mounted to the frame, and a plurality of members, wherein each member is coupled to an actuator and to the frame.
